(19) United States
(12) Patent Application Publication
(10) Pub. No.: US 2006/0192494 A1
(43) Pub. Date: Aug. 31, 2006

(54) In-situ sealed carbon nanotube vacuum device

(76) Inventor: Sal T. Mastroianni, Mesa, AR (US)

Correspondence Address: INGRASSIA FISHER & LORENZ, P.C., 7150 E. CAMELBACK, STE. 325, SCOTTSDALE, AZ, 85251, US

(21) Appl. No.: 11/065,936

(22) Filed: Feb. 25, 2005

(51) Int. Cl. G09G 3/10

(52) U.S. Cl. 315/169.1

(57) ABSTRACT

A process is provided for fabricating an in-situ sealed integrated vacuum device (30). The process comprises growing an electron emissive material (24) on a cathode layer (14) within a well (22) surrounded by a dielectric (16, 20), and forming, in a vacuum, an anode (32) on the dielectric (16, 20) and above the well (22), thereby encasing the vacuum within the well (22).

### FIELD OF THE INVENTION

The present invention generally relates to an integrated circuit device and more particularly to an in-situ sealed integrated vacuum device.

### BACKGROUND OF THE INVENTION

Vacuum tube technology has provided many advances over the years, but has been replaced for the most part by semiconductor technology. Semiconductor devices are smaller, cooler, and electronically more efficient. Flat panel displays and traveling wave tubes are two types of microelectronic devices currently used in, for example, high definition thin displays, and power amplifiers for high frequency applications. Electron emission typically is directed from a cathode into a vacuum towards an anode that is biased positive with respect to the cathode. A gate electrode may be positioned between the cathode and anode to further attract electrons from the cathode and focus the electron beam towards the anode.

Microwave tube amplifiers having electrons traveling in a vacuum are capable of providing microwave energy several orders of magnitude higher than semiconductor microwave amplifiers having electrons traveling in the semiconductor material. Electrons can travel much faster in a vacuum than in a semiconductor material. This greater speed of tube amplifiers allows for larger devices without an unacceptable increase in transit time of the electrons. And since the microwave tube amplifiers are larger, they generally provide more power.

Conventional microwave tube devices comprise a thermionic emission cathode of Ir—Re—Os alloys or oxides such as BaO/CaO/SrO or BaO/Cao/Al₂O₃, coated or impregnated with metals, e.g., tungsten. The heating of these cathodes under normal operating conditions, on the order of 1000° C. and higher, reduces cathode life. Furthermore, commercially undesirable delays of several minutes may be required to bring the cathodes up to this high temperature before they will emit electrons.

A typical field emission device comprises many thousands of emitters, for example, Spindt tips or carbon nanotubes, grown above the cathode and spaced from the anode. The electron emission of a field emission device may be controlled by applying a voltage to a gate electrode, is repeatable from one emitter to the next, has minimal noise (electron fluctuation), and is resistant to ion bombardment, chemical reaction with residual gases, temperature extremes, and arcing. The field emission device comprises emitters arranged in rows and columns and coupled to a first conductive line associated with each row and a second conductive line associated with each column. Each emitter, or pixel, is activated by applying a bias to the first and second conductive lines coupled thereto. For a carbon nanotube device, there typically would be several nanotubes for each emitter in order to supply sufficient electron flow.

A typical field emission structure, comprising many cathode emitters and control gates, is typically subsequently joined to a separate overlying structure containing the anode. The space between the anode and cathode structures is evacuated, and the composite structure is then sealed. The creation of evacuated chambers by this method, requiring one evacuation step and resulting in many pairs of cathode emitters and anodes being concurrently evacuated is thus acceptable from a cost point of view, but would be prohibitive if each pair of cathode emitter and associated anode would have to be individually singulated, joined, and individually evacuated and sealed.

Furthermore, combining RF technology on chip has proven very expensive and has several limitations. Wireless integrated circuits typically contain digital/analog circuitry, e.g., CMOS for control logic and signal processing, and RF circuitry for the wireless function. This RF circuitry can be implemented in CMOS and integrated with the control logic if CMOS RF frequency limits are not exceeded. It can be integrated as SiGe BiCMOS to extend the operating frequency, or can be broken out as a discrete section, for example using GaAs or InP devices for even higher frequencies. However, though integrated CMOS solutions are low cost, they are limited in operating frequency and maximum RF power. Electron transit time for GaAs, InP, or SiGe materials produce a limitation in maximum frequency of about 100 GHz when used as oscillators or amplifiers. They also suffer from noise coupling through the common semiconductor substrate housing both transmit and receive circuitry. Discrete RF solutions in the higher frequency ranges (e.g., millimeter wave regime), use expensive compound semiconductor technology. Although higher than available in CMOS, RF power and operating frequency also limit RF broadband communication or imaging applications.

Accordingly, it is desirable to provide an in-situ sealed integrated vacuum device. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A process is provided for fabricating an in-situ sealed integrated vacuum device. The process comprises growing an electron emissive material on a cathode layer within a well surrounded by a dielectric, and forming, in a vacuum, an anode on the dielectric and above the well, thereby encasing the vacuum within the well.

### BRIEF DESCRIPTION OF THE DRAWINGS

The present invention will hereinafter be described in conjunction with the following drawing figures, wherein like numerals denote like elements, and

FIG. 1 is side view of a known nanotube emitter device;

FIG. 2 is a side view of a carbon nanotube emitter device in accordance with a preferred embodiment of the present invention;

FIG. 3 is a schematic of a triode circuit using the embodiment of FIG. 2; and

FIG. 4 is an array of the carbon nanotube emitter devices of FIG. 2.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

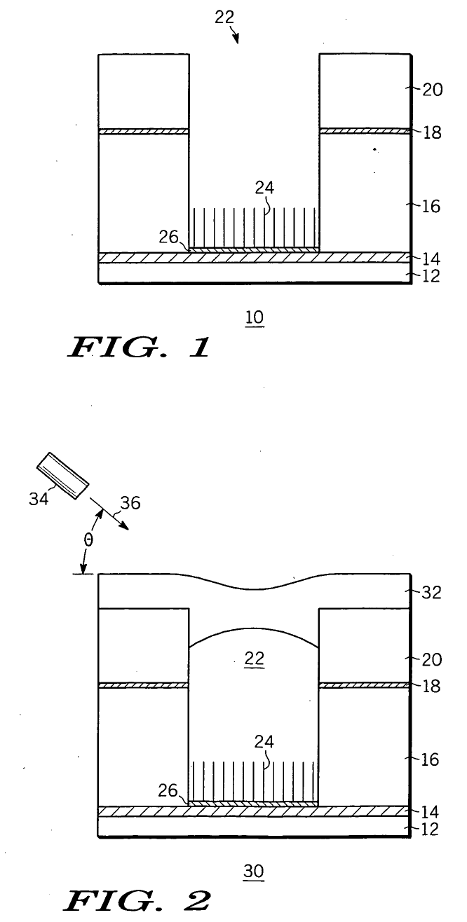

Referring to FIG. 1, the field emission device 10 is a simple example of cathode structures of carbon nanotube devices of the known art and includes a metal cathode layer 14 deposited on the substrate 12. A dielectric layer 16 is deposited over the metal cathode layer 14. A gate metal layer 18 is deposited over the dielectric layer 16. Another dielectric layer 20 is deposited on the gate metal layer 18. A lithographic etch is performed to create the well 22 in the dielectric layers 14 and 16 and gate metal layer 18. Carbon nanotubes 24 are then grown in a manner well known in the industry either on the metal cathode layer 14 or an optional catalytic layer 26. There are many variations known by those in the industry of this device 10, any of which may be used with the present invention. For example, several carbon nanotube devices have been published in which the electron flow from the emitters may be focused. A separate defined anode structure is attached subsequent to the formation of the cathode layer 14 and gate metal layer 18, and the space between such anode and substructure is evacuated.

Referring to FIG. 2 and in accordance with the preferred embodiment of the present invention, the substrate 12 preferably comprises silicon but may comprise other materials used in the industry, for example, glass or ceramic. The cathode layer 14 comprises a conductive metal, for example, molybdenum or copper and is approximately 0.5 microns thick. The gate layer 18 comprises a conductive metal, for example, molybdenum or copper and is preferably about 0.5 microns thick. The dielectric layers 16 and 20 comprise, for example, silicon oxide and would preferably be approximately 4.5 micron thick. Although a well 22 is preferred, it should also be understood that a trench could alternatively be formed. As used herein, well is considered to include a trench. The optional catalytic layer 26 preferably comprises nickel and is approximately 0.5 microns thick. Although only a few carbon nanotubes 24 are shown, those skilled in the art will understand that any number of carbon nanotubes 24 could be grown in the well 22. The carbon nanotubes 24 preferably would have a height of 0.5 to 2.0 microns.

The device 30 (as part of the resident wafer, not shown) is spun on a central axis and an anode 32 is deposited on the dielectric layer 20. As the device 30 spins, a source 34, such as a metal evaporator or e-beam deposition system, provides the anode 32 material as shown by the arrow 36 at an angle θ to the device 30 and therefore at an angle θ to the sides of the well 22. In other embodiments, the wafer may be stationary and the source 34 may move in a circular fashion when a well is utilized. Note that when a trench is formed, relative movement between the source 34 and the trench would be a sidewise motion, not a circular motion. Alternatively, the anode could be formed along and within the sides of a trench by use of a shadow mask in a manner known in the industry. The anode comprises a metal, preferably molybdenum or copper and will be 2.0 to 4.0 microns thick from the lowest portion within the well 22 to the top after termination of the deposition. Key parameters which include the angle θ of deposition, the height to width ratio of the well, and the height of the emitters must be chosen carefully so the anode 32 material does not form as low as the gate electrode 18 or on the carbon nanotubes 24. After deposition, the anode would be planarized to about 1.0 micron above the top of the dielectric layer 20, thereby removing any unevenness at the top of the deposition created by the anode 32 material forming within the well 22. Since the process takes place within a vacuum in a deposition chamber (not shown), the well 22 maintains the vacuum in the well 22 to the same vacuum level as was present in the vacuum deposition chamber after the anode 26 is deposited. Typical vacuum levels are in the range of 10⁻⁴ to 10⁻⁷ Torr. The total well 22 depth created preferably would have a depth to width ratio in the range of between 1:1 and 20:1. The spacing from the bottom of the anode to the top of the emitters compared to the width of the well should be in the range of 2:1 to 1:2. It should be understood that although carbon nanotubes 24 are used in this description of the preferred embodiment, any high aspect ratio (height to diameter) material used in cold cathode electron emission devices could be used.

When voltages are applied to the cathode layer 14, the gate electrode layer 18, and the anode 32, the cathode layer 14 voltage is supplied to the catalyst layer 26 and nanotubes 24. Typical voltages on the cathode layer 14, gate electrode layer 18, and anode 32 are 0.0 volts, 0-50.0 volts, and 10.0-100 volts, respectively. Electrons are extracted from the nanotubes 24 by the local electric field which is dominated by the field generated by the gate electrode layer 18 and directed to the anode 32 through the vacuum in the well 22.

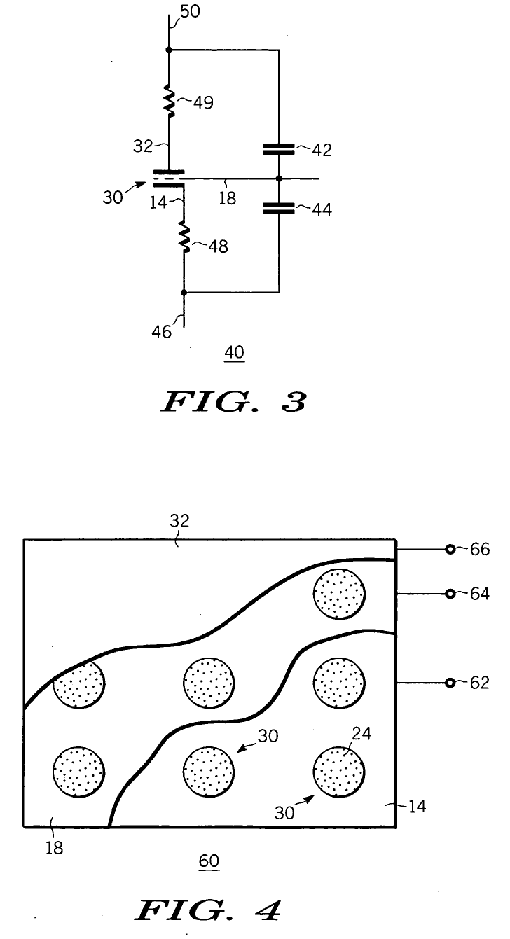

Referring to FIG. 3, circuitry 40 includes the device 30 functioning as a triode. A parasitic capacitor 42 is shown coupled between the terminal 50 and the gate 18. A parasitic capacitor 44 is shown coupled between the gate 18 and a terminal 46. A parasitic resistor 48 is coupled between the cathode 14 and the terminal 46. The anode is further coupled to the terminal 50 through parasitic resistor 49. Parasitic components, not necessarily desired, are an always occurring natural result of the materials and topography used in the device design.

This ability to pass electrons through a short distance separating the cathode 14 and the anode 32, such distance being held under vacuum, defines a vacuum triode which makes available a new spectrum, or frequency range possibly extending above 1,000 GHz, for integrated RF devices. Prior art RF integrated devices passed electrons through a semiconductor material, which is much slower than electrons passing through a vacuum. The actual obtainable frequency of a triode is determined by the size of the parasitic capacitors 42, 44 in conjunction with the parasitic resistors 48, 49 and may limit actual frequency use below that which would be obtainable by the intrinsic vacuum triode were it not to be limited by such parasitic elements.

Referring to FIG. 4, an array 60 of the devices 30 are shown in a schematic cutaway view. Although only one of the devices 30 may be used for small current requirements, many of the devices 30 may be placed in parallel to obtain a larger current. While only nine of the devices 30 are shown in FIG. 4, it should be understood that many of the devices 30 may be placed in an array. Electrical connections 62, 64, 66 are made to the cathode layer 14, gate layer 18, and anode 24, respectively. Alternatively, each individual device within an array of such devices could be individually addressed, for possible applications such as pixilated imaging or phased array imaging.

Examples of further refinements of this invention would include additional control gates, to further focus electron flow and minimize loss of electrons to the various elements of a triode. Such additional control gates would result in tetrodes (one additional gate added to a triode, thus now comprising four elements) and pentodes (five elements). Those in the industry would recognize these as evolutionary steps beyond the simple triode described.

Although the implementation of this invention has been described as a stand-alone structure, one would recognize the ability to construct this device on a pre-existing structure comprising functional silicon or other semiconductor integrated circuits.

The invention described herein overcomes limitations of prior art such as integrated CMOS solutions which are low cost but are limited in operating frequency and maximum RF power, and discrete RF solutions in the higher frequency ranges (e.g., millimeter wave regime) that use expensive compound semiconductor technology.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A process for forming a device, comprising:
growing an electron emissive material on a cathode layer within a well surrounded by a dielectric; and
forming, in a vacuum, an anode on the dielectric and above the well, thereby encasing the vacuum within the well.

2. The process of claim 1 wherein the forming step comprises:
spinning the substrate; and
depositing material for the anode from an angle to sidewalls of the well.

3. The process of claim 1 wherein the growing step comprises growing high aspect ratio emitters.

4. The process of claim 1 wherein the growing step comprises growing carbon nanotubes.

5. The process of claim 1 further comprising forming a gate electrode between the anode and the electron emissive material.

6. The process of claim 5 further comprising forming at least one more gate electrode between the anode and the high aspect emitters.

7. The process of claim 5 wherein the growing and forming steps result in a plurality of wells, the anodes of each being coupled together, the cathodes of each being coupled together, and the gate electrodes of each being coupled together.

8. The process of claim 5 further comprising, during the growing and forming steps, forming a plurality of wells, each having a cathode, anode and gate electrode that may be uniquely accessed.

9. A process comprising:
providing a substrate having a first and second portion;
forming a dielectric layer over the first portion, thereby creating a well over the second portion;
growing high aspect ratio emitters on the second portion and in the well;
forming, in a vacuum, an anode on the dielectric layer and above the well, wherein the anode, dielectric layer, and substrate encase the vacuum in the well.

10. The process of claim 9 wherein the forming step comprises:
spinning the substrate; and
depositing material for the anode from an angle to sidewalls of the well.

11. The process of claim 9 wherein the growing step comprises growing high aspect ratio emitters.

12. The process of claim 9 wherein the growing step comprises growing carbon nanotubes.

13. The process of claim 9 further comprising forming a gate electrode between the anode and the electron emissive material.

14. The process of claim 13 further comprising forming at least one more gate electrode between the anode and the high aspect emitters.

15. The process of claim 13 wherein the growing and forming steps result in a plurality of wells, the anodes of each being coupled together, the cathodes of each being coupled together, and the gate electrodes of each being coupled together.

16. The process of claim 13 further comprising, during the growing and forming steps, forming a plurality of wells, each having a cathode, anode and gate electrode that may be uniquely accessed.

17. A. device comprising:
a substrate having first and second portions;
a cathode metal layer over at least the second portion;
a first dielectric layer over the substrate on the first portion;
a gate extraction metal layer over the first dielectric layer;
a second dielectric layer over the gate extraction metal layer, the first and second dielectric layers and the gate extraction metal layer defining a well over the second portion;
at least one emitter comprising a high aspect ratio conductive material over the cathode metal layer in the well; and
an anode formed in-situ on the second dielectric layer and above the well, the anode, first and second dielectric layers, the gate extraction metal layer and the substrate cooperating to maintain a vacuum in the well.

18. The device of claim 17 wherein the at least one emitter comprises at least one carbon nanotube.

19. The device of claim 17 further comprising a gate extraction metal layer positioned between the anode and the at least one emitter.

20. The device of claim 19 further comprising at least one more gate extraction metal layer positioned between the anode and the at least one emitter.

21. The device of claim 19 further comprising a plurality of the devices coupled in parallel.

22. The device of claim 19 further comprising a plurality of the devices, each having a cathode, anode and gate electrode that may be uniquely accessed.
